(19) United States
(12) Patent Application Publication
(10) Pub. No.: US 2010/0058327 A1
(43) Pub. Date: Mar. 4, 2010

(54) METHODS AND SYSTEMS FOR PROVIDING CUSTOMIZED ACTIONS RELATED TO SOFTWARE PROVISIONING

(76) Inventor: Michael Paul Dehaan, Morrisville, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 12/200,552

(22) Filed: Aug. 28, 2008

(51) Int. Cl. G06F 9/445

(52) U.S. Cl. 717/176; 717/174

(57) ABSTRACT

A provisioning server can be configured to determine software provisioning processes to be performed on one or more target machines. The software provisioning processes can include one or more customized actions to be taken before, during, or after the software provisioning processes, upon the occurrence of a particular event. The customized actions can be performed by the provisioning server, the target machines, provisioning clients assisting the provisioning, or by the software being provisioned.

### FIELD

This invention relates generally to software provisioning.

### DESCRIPTION OF THE RELATED ART

Software provisioning is the process of selecting a target machine, such as a server, loading the appropriate software (operating system, device drivers, middleware, and applications), and customizing and configuring the system and the software to make it ready for operation. Software provisioning can entail a variety of tasks, such as creating or changing a boot image, specifying parameters, e.g. IP address, IP gateway, to find associated network and storage resources, and then starting the machine and its newly-loaded software. Typically, a system administrator will perform these tasks using various tools because of the complexity of these tasks. Unfortunately, there is a lack of provisioning control tools that can adequately integrate and automate these tasks.

Additionally, the provisioning control tools typically lack flexibility in performing customized actions during the software provisioning. The provisioning control tools typically allow a basic provisioning without any input or modification to the provisioning from a user. As such, customs actions cannot be requested or performed during or after the software provisioning. Additionally, the provisioning control tools typically are limited in the ability to configure and modify software being provisioned. Accordingly, it would be desirable to provide a provisioning environment that can perform customized and requested actions during software provisioning.

### BRIEF DESCRIPTION OF THE DRAWINGS

Various features of the embodiments can be more filly appreciated, as the same become better understood with reference to the following detailed description of the embodiments when considered in connection with the accompanying figures, in which:

FIG. 1 illustrates an overall provisioning environment in which various embodiments of the present teachings can be practiced;

FIG. 2 illustrates the overall provisioning environment in which a provisioning server can enable customized and requested actions during software provisioning, according to various embodiments;

FIG. 3 illustrates an exemplary hardware configuration for a provisioning server, according to various embodiments; and

FIG. 4 illustrates a flowchart for enabling customized and requested actions during software provisioning, according to various embodiments.

### DETAILED DESCRIPTION OF EMBODIMENTS

For simplicity and illustrative purposes, the principles of the present invention are described by referring mainly to exemplary embodiments thereof However, one of ordinary skill in the art would readily recognize that the same principles are equally applicable to, and can be implemented in, all types of information and systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments of the present teachings relate to systems and methods for providing customized and requested actions during software provisioning in a software provisioning environment. More particularly, a provisioning server can determine customized actions to be performed during software provisioning and can generate the appropriate mechanisms to perform the customized actions.

In embodiments, the provisioning server can be configured to determine software provisioning processes to be performed on one or more target machines. The software provisioning processes can include one or more customized actions to be taken before, during, or after the software provisioning processes, upon the occurrence of a particular event. The customized actions can be performed by the provisioning server, the target machines, provisioning clients assisting the provisioning, or by the software being provisioned.

In embodiments, the provisioning server can be configured to enable customized actions to be performed by the the target machines, the provisioning clients, and/or by the software being provisioned, upon the occurrence of a particular event. In particular, the provisioning server can be configured to modify a configuration file of the provisioning process to enable the customized actions to be performed upon the occurrence of the event. The configuration file can include commands to direct the target machines, the provisioning clients, and/or by the software being provisioned to perform the customized actions, upon the occurrence of the events.

In embodiments, the provisioning server can be configured to enable customized actions to be performed by the provisioning server, upon the occurrence of a particular event. In particular, the provisioning server can be configured to maintain a record of customized actions to be performed for the software provisioning process. The record can be configured to include the events associated with commands to perform the related customized actions. To perform the actions, the provisioning server can be configured to monitor the software provisioning process for the occurrence of the events. Upon occurrence of a particular event, the provisioning server can be configured to retrieve the commands from the record and perform the related customized action utilizing the commands.

By enabling customized actions, the provisioning server can perform customized software provisioning processes tailored to the specific situations. As such, the provisioning server can provide flexible software provisioning that can be adapted to a variety of situations. Additionally, by providing customized actions, the provisioning server can receive requests for specific customized actions from users of the software provisioning environment.

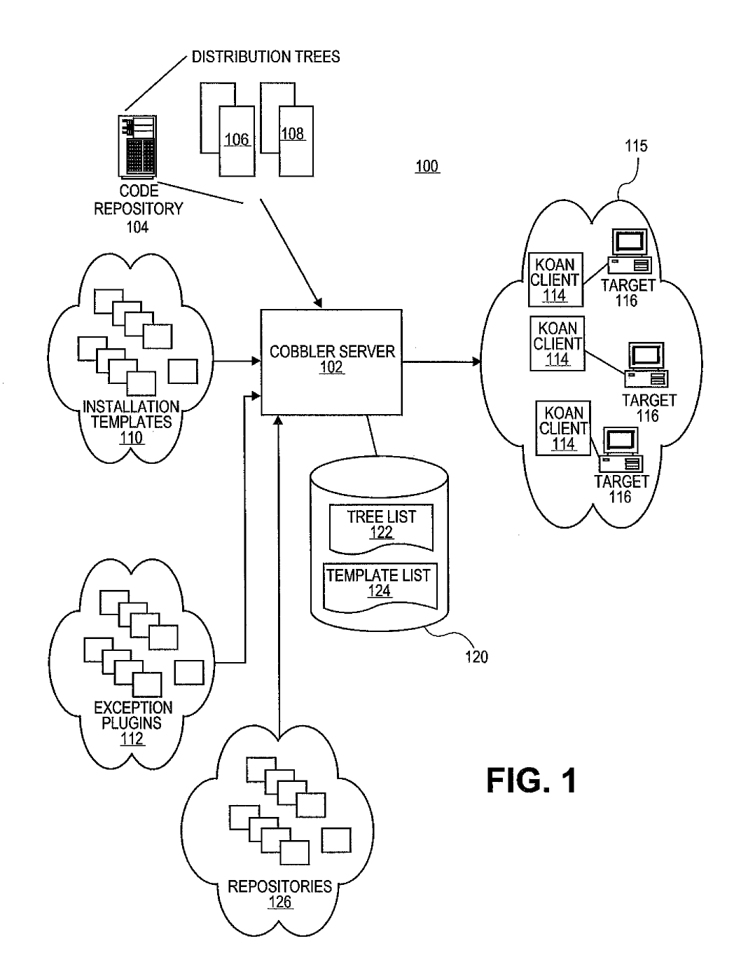

FIG. 1 illustrates an overall provisioning environment 100, in systems and methods for the execution, management, and monitoring of software provisioning, according to exemplary aspects of the present disclosure. Embodiments described herein can be implemented in or supported by the exemplary environment illustrated in FIG. 1. The provisioning environment 100 provides a unified provisioning environment, which comprehensively manages the tasks related to software provisioning.

In particular, the provisioning environment 100 can manage software provisioning using a hierarchy of commands. In exemplary embodiments, the hierarchy can include at least four levels of commands. The lowest level in the hierarchy can comprise distribution commands, which primarily handle base operating system specific tasks of provisioning. The second level can comprise profile commands, which associate a configuration file, such as a kickstart file for Linux or other operating system, with a distribution and optionally allow for customization. The third level comprises system commands, which associate remote systems that are involved with the provisioning of the software. The fourth level comprises repository commands, which address configurations and tasks related to updating the software, remote installation procedures, and optionally customizing the software.

The provisioning environment 100 provides several capabilities and advantages over the known provisioning solutions. For example, the present invention is capable of handling a variety of forms of installations, such as preboot execution environment (“PXE”), virtualization, re-installations, and image installations.

In exemplary aspects, the provisioning environment 100 enables integrating virtualization into a PXE provisioning infrastructure and provides several options to reinstall running machines as well. The provisioning environment 100 can integrate mirroring of package repositories with the provisioning process, so that a provisioning server may serve as a central mirror point of contract for all of an organization's software needs. In aspects, a set of remote mirrored repositories can automatically be used by provisioned systems without additional setup.

Reference will now be made in detail to the exemplary aspects the provisioning environment 100. The provisioning environment 100 can be applied to provisioning any form of software, such as Windows systems, UNIX systems, and Linux systems. In the exemplary description that follows, FIG. 1 is presented to explain the provisioning environment 100 for provisioning software, such as Linux, and Linux based software, such as Fedora and Red Hat Enterprise Linux by Red Hat, Inc.

In provisioning of software such as Linux, many system administrators use what is known as the “kickstart” installation method. Kickstart files are files that specify the intended configuration of the software being provisioned. Kickstart files can be kept on a server and can be read by individual computers during the installation. This installation method allows the use a single or relatively few standard kickstart files to install Linux on multiple machines, making it ideal for network and system administrators.

The kickstart file can be a simple text file, containing a list of items, each identified by a keyword. In general, a kickstart file can be edited with any text editor or word processor that can save files as ASCII text. One skilled in the art will recognize that the present invention may be applied to non-kickstart files in software provisioning. For example, configuration files such as AutoYAST Answer files used in Novell SuSe Linux and Sun Solaris Jumpstart files may also be used by the provisioning environment 100.

Typically, a kickstart file can be copied to the boot disk, or made available on the network. The network-based approach is most commonly used, as most kickstart installations for software provisioning, such as Linux systems, tend to be performed via a network using NFS, FTP, or HTTP on networked computers. Administrators also find it desirable that kickstart installations can be performed using a local CD-ROM, or a local hard drive.

Using kickstart files, a system administrator can create a single file containing the parameters that are needed to complete a typical software installation. For example, kickstart files specify parameters related to: language selection; mouse configuration; keyboard selection; boot loader installation; disk partitioning; network configuration; NIS, LDAP, Kerberos, Hesiod, and Samba authentication; firewall configuration; and package selection.

According to exemplary aspects illustrated in FIG. 1, the provisioning environment 100 can include a provisioning server 102, a code repository 104 which provides access to distributions 106 and 108, a set of installation templates 110, a set of exception plugins 112, a helper client 114 running on target machines 116 in a network 115, a provisioning database 120 which comprises a distribution tree list 122 and template list 124. Each of these components will now be further described.

The provisioning server (from herein referred to as a “cobbler”) 102 is responsible for: serving as a extensible markup language remote procedure call (XMLRPC) handler; linking to or mirroring install distribution trees and a configuration database; hosting kickstart templates; hosting plugins, generating installation images, and the like. The cobbler server 102 can be implemented as software, such as Python code, installed on a boot server machine and provides a command line interface for configuration of the boot server. In addition, the cobbler server 102 can make itself available as a Python application programming interface (API) for use by higher level management software (not shown). The cobbler server 102 supports provisioning via PXE, image (TSO) installation, virtualization, re-provisioning. As will be described later, the last two modes are performed with the assistance of a helper client 114.

The code repository 104 is responsible for hosting distributions 106 and 108. The code repository 104 may be implemented using well known components of hardware and software. Additionally, the code repository 104 can be include one or more repositories hosting distributions. The distributions 106 and 108 can include bundles of software that is already compiled and configured. The distributions 106 and 108 may be in the form of either rpm, deb, tgz, msi, exe formats, and the like. For example, as Linux distributions., the distributions 106 and 108 are bundles of software that comprise the Linux kernel, the non-kernel parts of the operating system, and assorted other software. The distributions 106 and 108 can take a variety of forms, from fully-featured desktop and server operating systems to minimal environments.

In exemplary aspects, the installation templates 110 are any data structure or processing element that can be combined with a set of installation configurations and processed to produce a resulting configuration file, such as a kickstart file.

In exemplary aspects, exception plugins 112 is software that interacts with cobbler server 102 to customize the provisioning of software. In general the exceptions plugins 112 are intended to address infrequent customization needs.

In exemplary aspects, the helper client (known as “koan”, which stands for “kickstart-over-a-network”) 114 can assist the cobbler server 102 during the provisioning processes. The koan 114 can allow for both network provisioning of new virtualized guests and destructive provisioning of any existing system. When invoked, the koan 114 can request profile information from a remote boot server that has been configured with the cobbler server 102. In some aspects, what the koan 114 does with the profile data depends on whether it was invoked with—virt or -replace-self.

In exemplary aspects, the koan 114 can enable replacing running systems as well as installing virtualized profiles. The koan 114 can also be pushed out to systems automatically from the boot server. In some aspects, the koan client 114 is also written in Python code to accommodate a variety of operating systems, machine architectures, etc.

In exemplary aspects, the network 115 can include a number of the target machines 116. The target machines 116 can represent the particular machines to which software provisioning is directed. The target machines 116 may represent a wide variety of computing devices, such as personal computers, servers, laptop computers, personal mobile devices, and the like. In some aspects, the target machines 116 can represent distributed computing environments such as cloud computing environments. Although FIG. 1 shows several of the target machines 116, the provisioning environment 100 can be capable of managing a wide range environments, such as datacenters with thousands of machines or server pools with just a few machines. Additionally, the cobbler server 102 can be connected to multiple networks 115.

In exemplary aspects, the provisioning database 120 can serve as a data storage location for holding data used by the cobbler server 102. For example, as shown, the provisioning database 120 can comprise the distribution tree list 122 and the template list 124. The distribution tree list 122 can provide an inventory of the distributions 106 and 108 that are hosted or mirrored by the cobbler server 102. The template list 124 can provide an inventory of the templates 110 that are hosted by the cobbler server 102.

As noted above, the cobbler server 102 can manage provisioning using a hierarchical concept of distribution commands, profile commands, system commands, and repository commands. This framework enables the cobbler server 102 to abstract the differences between multiple provisioning types (installation, reinstallation, and virtualization) and allows installation of all three from a common platform. This hierarchy of commands also permits the cobbler server 102 to integrate software repositories 126 with the provisioning process, thus allowing systems to be configured as a mirror for software updates and third party content as well as distribution content.

Distributions can contain information about base operating system tasks, such as what kernel and initial ramdisk (“initrd”) are used in the provisioning, along with other information, such as required kernel parameters. Profiles associate one of the distributions 106 and 108 with a kickstart file and optionally customize it further, for example, using plugins 112. Systems commands associate a hostname, IP, or MAC with a distribution and optionally customize the profile further. Repositories contain update information, such as yum mirror information that the cobbler server 102 uses to mirror repository 104. The cobbler server 102 can also manage (generate) DHCP configuration files using the templates 110.

In exemplary aspects, the cobbler server 102 can use a provisioning environment that is fully templated, allowing for kickstarts and PXE files to be customized by the user. The cobbler server 102 uses the concept of “profiles” as an intermediate step between the operating system and the installed system. A profile is a description of what a system does rather than the software to be installed. For instance, a profile might describe a virtual web server with X amount of RAM, Y amounts of disk space, running a Linux distribution Z, and with an answer file W.

In exemplary aspects, the cobbler server 102 can provide a command line interface to configure a boot server in which it is installed. For example, the format of the cobbler server 102 commands can be generally in the format of cobbler command [subcommand][—arg1=][—arg2=]. Thus, a user can specify various aspects of software provisioning via a single interface, such as a command line interface or other known interface. Examples of exemplary cobbler commands can be found in U.S. patent application Ser. No. 11/763,315, U.S. Patent Application Publication No. ______ and U.S. patent application Ser. No. 11/763,333, U.S. Patent Publication No. ______, the disclosures of which are incorporated herein, in their entirety, by reference.

According to exemplary aspects, a user can use various commands of the provisioning environment 100 to specify distributions and install trees hosted by the code repository 104, such as a distribution from the distributions 106 or 108. A user can add or import a distribution or import it from installation media or an external network location.

According to exemplar aspects, in order to import a distribution, the cobbler server 102 can auto-add distributions and profiles from remote sources, whether this is an installation media (such as a DVD), an NFS path, or an rsync mirror. When importing a rsync mirror, the cobbler server 102 can try to detect the distribution type and automatically assign kickstarts. By default in some embodiments, the cobbler server can provision by erasing the hard drive, setting up etho for DHCP, and using a default password. If this is undesirable, an administrator may edit the kickstart files in /etc/cobbler to do something else or change the kickstart setting after the cobbler server 102 creates the profile.

According to exemplary aspects,a user may map profiles to the distributions and map systems to the profiles using profile commands and systems commands of the provisioning environment 100. A profile associates a distribution to additional specialized options, such as a kickstart automation file. In the cobbler server 102, profiles are the unit of provisioning and at least one profile exists for every distribution to be provisioned. A profile might represent, for instance, a web server or desktop configuration.

According to exemplary aspects, a user can map systems to profiles using system commands. Systems commands can assign a piece of hardware with cobbler server 102 to a profile. Systems can be defined by hostname, Internet Protocol (IP) address, or MAC address. When available, use of the MAC address to assign systems can be preferred.

According to exemplary aspects, the user can map repositories and profiles using repository commands. Repository commands can address configurations and tasks related to updating the software, remote installation procedures, and optionally customizing the software. These repository commands can also specify mirroring of the provisioned software to remote servers. Repository mirroring can allow the cobbler server 102 to mirror not only install the trees 106 and 108, but also optional packages, third party content, and updates. Mirroring can be useful for faster, more up-to-date installations and faster updates, or providing software on restricted networks. The cobbler server 102 can also include other administrative features, such as allowing the user to view their provisioning configuration or information tracking the status of a requested software installation.

According to exemplary aspects, a user can utilize commands to create a provisioning infrastructure from a distribution mirror. Then a default PXE configuration is created, so that by default systems will PXE boot into a filly automated install process for that distribution. The distribution mirror can be a network rsyne mirror or a mounted DVID location.

According to exemplary aspects, the administrator uses a local kernel and initrd file (already downloaded), and shows how profiles would be created using two different kickstarts—one for a web server configuration and one for a database server. Then, a machine can be assigned to each profile.

According to exemplary aspects, a repo mirror can be set up for two repositories, and create a profile that will auto install those repository configurations on provisioned systems using that profile.

According to exemplary aspects, in addition to normal provisioning, the cobbler server 102 can support yet another option, called “enchant”. Enchant takes a configuration that has already been defined and applies it to a remote system that might not have the remote helper program installed. Users might want to use this command to replace a server that is being repurposed, or when no PXE environment can be created. Thus, the enchant option allows the remote the koan client 114 to be executed remotely from the cobbler server 102.

According to aspects, if the cobbler server 102 is configured to mirror certain repositories, the cobbler server 102 can then be used to associate profiles with those repositories. Systems installed under those profiles can be auto configured to use these repository mirrors in commands and, if supported, these repositories can be leveraged. This can be usefull for a large install base, fast installation and upgrades for systems are desired, or software not in a standard repository exists and provisioned systems are desired to know about that repository.

According to exemplary aspects, the cobbler server 102 may also keep track of the status of kickstarting machines. For example, the “cobbler status” will show when the cobbler server 102 thinks a machine started kickstarting and when it last requested a file. This can be a desirable way to track machines that may have gone inactive during kickstarts. The cobbler server 102 can also make a special request in the post section of the kickstart to signal when a machine is finished kickstarting.

According to exemplary aspects, for certain commands, the cobbler server 102 will create new virtualized guests on a machine in accordance to the orders from the cobbler server 102. Once finished, an administrator may use additional commands on the guest or other operations. The cobbler server 102 can automatically name domains based on their MAC addresses. For re-kickstarting, the cobbler server 102 can reprovision the system, deleting any current data and replacing it with the results of a network install.

According to exemplary aspects, the cobbler server 102 can configure boot methods for the provisioning requested by the user. For example, the cobbler server 102 can configure a PXE environment, such as a network card BIOS. Alternatively, the cobbler server 102 can compile and configure information for koan client 104. The cobbler server 102 can also optionally configured DHCP and DNS configuration information.

According to exemplary aspects, the cobbler server 102 can serve the request of the koan client 114. The koan client 114 can acknowledge the service of information of the cobbler server 102 and then can initiate installation of the software being provisioned. Additionally, the koan client 114 can either install the requested software, e.g., replace the existing operating system, or install a virtual machine.

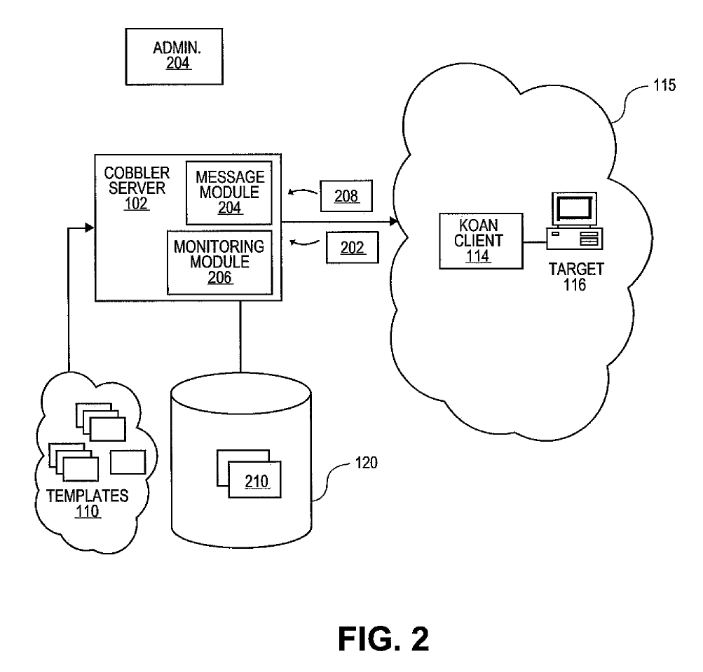

FIG. 2 illustrates aspects of the provisioning environment 100 that allows for customized actions to be performed during software provisioning, according to various embodiments. In embodiments, the provisioning environment 100 provides a cobbler server 102 that can enable customized actions to be performed during software provisioning.

In embodiments, the cobbler server 102 can be configured to determine software provisioning processes to be performed on one or more target machines 116. The software provisioning processes can be associated with one or more customized actions to be taken before, during, or after the software provisioning processes and upon the occurrence of a particular event. The software provisioning process can include any of the provisioning process describe above, such as installing software, re-installing software, virtualization, configuration of the cobbler server 102, configuration of the provisioning processes, configuration of machines 116 (network configuration, etc.), updates to the cobbler server 102, updates to target machines I 1 6, and the like.

In embodiments, the customized actions can be any type of actions, such as software provisioning processes, actions performed during the course of software provisioning, actions performed related to software provisioning, and any other type of actions capable of being performed by the cobbler server 102, the koan clients 114, the target machines 116, and/or software on the target machines 116. For example, the customized actions can include performing software provisioning processes; performing software configuration, performing additional software provisioning processes, sending notification to users, generating log entries, setting up security and authentication protocols and procedures, configuring security and authentication protocols and procedures, setting up additional services, performing hardware configuration, and the like.

In embodiments, the customized actions, associated with a provisioning process, can be performed by the cobbler server 102, by the target machine 116, by the koan client 114 assisting the provisioning, or by the software being provisioned. For example, the customized actions can include actions performed by the cobbler server 102 (additionally provisioning process, notification of a provisioning process occurring, notification of status of provisioning processes, configuration actions, etc.), actions performed the koan client 114 (additional provisioning processes, notification of status, configuration actions, etc.), and actions performed by software being provisioned (updating, configuration, requests for information, and the like).

In embodiments, the cobbler server 102 can be configured to determine the software provisioning processes based on a request 202 received from the target machine 116. The request 202 can include the details of the software provisioning processes and customized actions to be performed during the software provisioning process, upon occurrence of events. Additionally, the cobbler server 102 can be configured to determine the software provisioning process, independently, or the cobbler server 102 can be configured to determine the software provisioning processes at the direction of an administrator 204. As such, the cobbler server 102 can determine customized actions to be performed or receive the customized actions from the administrator 204.

In embodiments, the cobbler server 102 can be configured to enable the customized actions to be performed utilizing command and scripts to cause the cobbler server 102, the target machine 116, the koan client 114, or the software being provisioned to perform the customized action. The commands and scripts can be implemented in any type of format executable by the cobbler server 102, the target machine 116, the koan client 114, or the software being provisioned and capable of causing the cobbler server 102, the target machine 116, the koan client 114, or the software being provisioned to perform the customized action. The commands and scripts can be generated or created by or under the direction of the cobbler server 102, the target machine 116, the koan client 114, the software being provisioned, and/or any users of these.

In embodiments, the cobbler server 102 can be configured to enable customized actions to be performed by the the target machines 116, the provisioning clients 114, and/or by the software being provisioned, upon the occurrence of a particular event. In particular, the cobbler server 102 can be configured to modify a configuration file, such as a kickstart file, for a provisioning process to enable the customized actions to be performed upon the occurrence of the event. The configuration file can include commands and scripts to direct the target machines 116, the provisioning clients 114, and/or by the software being provisioned to perform the customized actions, upon the occurrence of the events.

For example, in an exemplary embodiment, during a software installation process on the target machine 116, the cobbler server 102 can determine that the installed software should request additional information (e.g. authentication certificate) once the software is installed. As such, the cobbler server 102 can be configured to retrieve the configuration template for the software installation from the templates 110 and modify the configuration template so that the generated configuration file includes commands or scripts to instruct the software to request the information once installed. When the software installation process is performed on the target machine 116 using the modified configuration file, the commands or scripts will instruct the installed software to request the information once the installation is completed.

In embodiments, the cobbler server 102 can be configured to enable customized actions to be performed by the cobbler server 102, upon the occurrence of a particular event. In particular, the cobbler server 102 can be configured to maintain records of customized actions to be performed for the software provisioning processes. The record can be configured to include an identification of the software provisioning process and the events associated with commands and scripts to perform the related customized actions. To perform the actions, the cobbler server 102 can be configured to monitor the software provisioning processes for the occurrence of the events. Upon occurrence of a particular event, the cobbler server 102 can be configured to retrieve the appropriate commands from the records and perform the related customized action utilizing the commands and scripts..

In embodiments, to monitor the software provisioning processes, the cobbler server 102 can be configured to include a monitoring module 206. The monitoring module 206 can be configured to monitor events occurring in internal provisioning processes and events occurring in provisioning processes on the target machines 116. The monitoring module 206 can be implemented as a portion of the code for the cobbler server 102. Likewise, the monitoring module 202 can be implemented as a separate software tool accessible by the cobbler server 102. The monitoring module 202 can be written in a variety of programming languages, such as JAVA, C++, Python code, and the like to accommodate a variety of operating systems, machine architectures, etc. Additionally, the monitoring module 202 can be configured to include the appropriate application programming interfaces (“APIs”) to communicate with and cooperate with other components of the cobbler server 102 and the koan clients 114 and target machines 116.

In embodiments, the monitoring module 206 can be configured to monitor the internal provisioning processes occurring in the cobbler server 102. In particular, the monitoring module 206 can be configured to monitor the internal processes of the cobbler server 102 for particular events. When a particular events occurs, the monitoring module 206 can be configured to retrieve the commands or scripts associated with the event. The monitoring module 206 can be configured to execute the commands to perform the customized actions or send the commands to the cobbler server 102 to execute the commands or scripts.

For example, in an exemplary embodiment, events such as such as changes to the configuration, distributions, templates or profiles of the cobbler server 102 can be associated with customized actions such as notifying users of the changes, distributing the changes across the software provisioning environment 100, and the like. The monitoring module 206 can be configured to monitor for these events. If these events occur, the monitoring module 206 can be configured to retrieve the commands or scripts associated with event in order to perform the customized actions.

In embodiments, the monitoring module 206 can be configured to monitor events occurring on the target machines 116 or the koan client 114. In particular, the monitoring module 206 can be configured to receive event messages 208 from the target machines 116 on which provisioning process are being performed. The monitoring module 206 can be configured to receive the event messages 208 from the koan client 114 assisting the target machine 116 during the software provisioning. Additionally, the monitoring module 206 can be configured to receive the event messages 202 from the target machine 116 or other other software instantiated (operating systems, installation programs, and the like) on the target machine 116.

In embodiments, the event messages 208 represent events occurring related to provisioning process provided by the cobbler server 102. For example, the event messages 208 can include an identification of the provisioning processes and details of the provisioning processes. The details can include a description of the provisioning processes, the progress of the provisioning processes (amount of the processes completed, events occurring during the provisioning process, portions of the processes complete) the integrity of the processes (still in progress, stalled, terminate early, errors), details of any errors, the completion of the provisioning processes, and the like.

For example, in an exemplary embodiment, the monitoring module 206 can be configured to monitor the status of provisioning processes occurring on the target machines 116. As such, the monitoring module 206 can receive the event messages 208 from the target machines 116 that include status information. In response to receiving the status information, the monitoring module 206 can be configured to update a log, notify the administrator 204 of the status of the provisioning process, perform additional provisioning process upon completion, and the like.

In embodiments, to perform the customized action when an event occurs either internally or externally, the cobbler server 102 can be configured to maintain records 210. The cobbler server 102 can be configured to maintain a record 210 for each provisioning process that has associated customized actions. Record 210 can be maintained for general provisioning processes and records 210 can be maintained for specific provisioning processes, for example a specific provisioning process undertaken for the target machines 116. The records 210 can be configured to include an identification of the provisioning process and the events trigging customized actions associated with the commands and scripts for performing the associated customized actions. The records 210 can be maintained in a repository, such as database 120.

In order to retrieve and perform the customized actions, the monitoring module 206 can be configured to include an event record. The event record includes events to be monitor by the monitoring module that have associated customized actions. The event record also include a link to the records 210 which references the a particular event to the appropriate record 210. As such, the monitoring module 206 can be configured to monitor the provisioning processes for the events in the event record. Once an event occurs, the monitoring module can retrieve the associated commands and scripts from linked record 210 for performing the customized action. Additionally, the monitoring module 206 can directly maintain records 210 in order to monitor events that have associated customized actions. As such, the monitoring module 206 can be configured to perform the monitoring by using the records 210 as the event record.

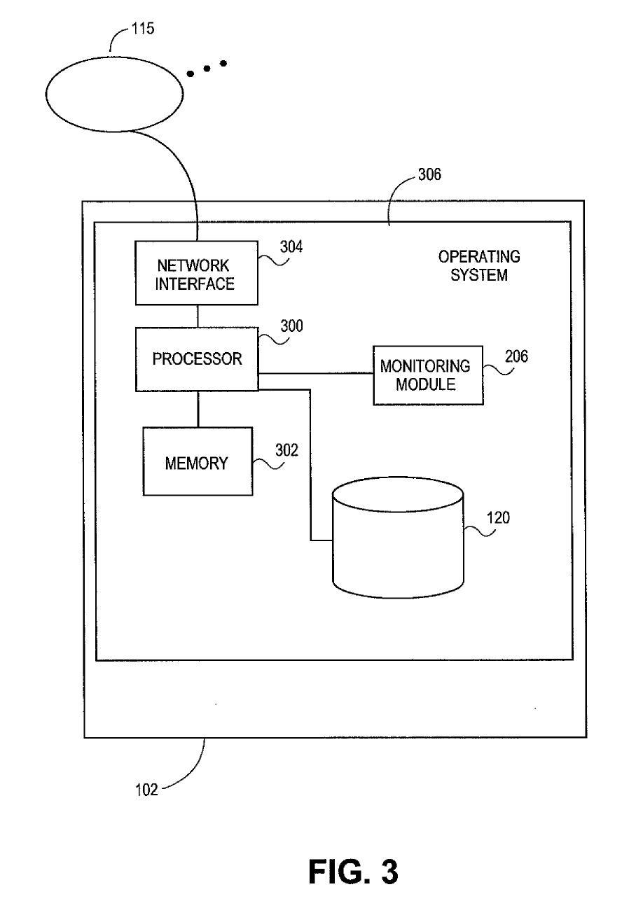

FIG. 3 illustrates an exemplary diagram of hardware and other resources that can be incorporated in the cobbler server 102 configured to communicate with the network 115 and the target machines in network 115, according to embodiments. In embodiments as shown, the cobbler server 102 can comprise a processor 300 communicating with memory 302, such as electronic random access memory, operating under control of or in conjunction with operating system 306. Operating system 306 can be, for example, a distribution of the Linux™ operating system, the Unix™ operating system, or other open-source or proprietary operating system or platform. Processor 300 also communicates with the provisioning database 120, such as a database stored on a local hard drive. While illustrated as a local database in the cobbler server 102, the provisioning database 120 can be separate from the cobbler server 102 and the cobbler server 102 can be configured to communicate with the remote provisioning database 120.

Processor 300 further communicates with network interface 304, such as an Ethernet or wireless data connection, which in turn communicates with one or more networks 115, such as the Internet or other pubic or private networks. Processor 300 also communicates with the provisioning database 120 and the monitoring module 206, to execute control logic and perform the provisioning processes and the monitoring processes described above. Other configurations of the cobbler server 102, associated network connections, and other hardware and software resources are possible.

While FIG. 3 illustrates the cobbler server 102 as a standalone system comprising a combination of hardware and software, the cobbler server 102 can also be implemented as a software application or program capable of being executed by a convention computer platform. Likewise, the cobbler server 102 can also be implemented as a software module or program module capable of being incorporated in other software applications and programs. In either case, the cobbler server 102 can be implemented in any type of conventional proprietary or open-source computer language.

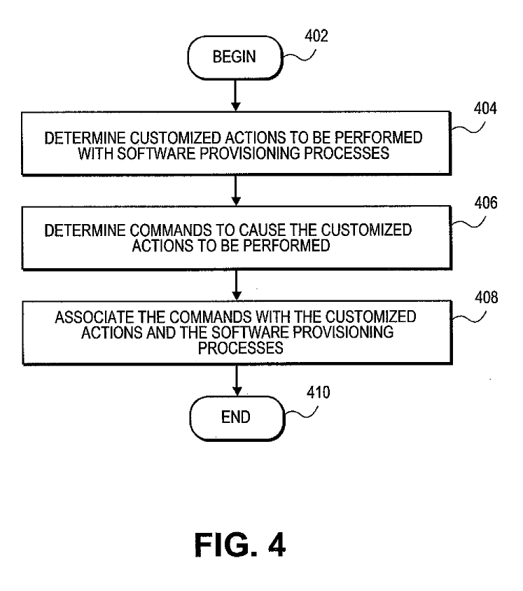

FIG. 4 illustrates a flow diagram of overall processes for enabling customized actions in the provisioning environment 100, according to embodiments of the present teachings. In 402, processing can begin. In 404, the cobbler server 102 can determine customized actions to be performed with software provisioning processes. For example, the cobbler server 102 can determine customized actions and the software provisioning processes based on a request 202 received from the target machine 116. The request 202 can include the details of the software provisioning processes and customized actions to be performed during the software provisioning process, upon occurrence of events. Additionally, the cobbler server 102 can determine the software provisioning process, independently, or the cobbler server 102 can determine the software provisioning processes at the direction of an administrator 204. As such, the cobbler server 102 can determine customized actions to be performed or receive the customized actions from the administrator 204.

In 406, the cobbler server 102 can determine commands to cause the customized actions to be performed. For example, the cobbler server can determine commands to enable customized actions to be performed by the cobbler server 102, by the target machines 116, by the provisioning clients 11 4, and/or by the software being provisioned, upon the occurrence of a particular event. The commands can be generated or created by or under the direction of the cobbler server 102, the target machine 116, the koan client 114, the software being provisioned, and/or any users of these. To determine the commands, the cobbler server 102 can locate, receive, retrieve, and/or generate the commands. For actions by the target machines 116, by the provisioning clients 114, and/or by the software being provisioned, the cobbler server 102 can generate a modified configuration file, such as a kickstart file, for a provisioning process to enable the customized actions to be performed upon the occurrence of the event. The cobbler server 102 can modify the configuration template associated with the provisioning process in order to generate the modified configuration file.

In 408, the cobbler server 102 can associate the commands with the customized actions and the software provisioning processes. For actions by the target machines 116, by the provisioning clients 114, and/or by the software being provisioned, the cobbler server 102 can transmit the modified configuration file to the target machines 116, the provisioning clients 114, and/or the software being provisioned or include the modified configuration file with the other information sent (software distribution, software update, and the like).

For actions by the cobbler server 102, the cobbler server 102 can be configured to maintain records 210. The records 210 can be configured to include an identification of the provisioning process and the events trigging customized actions associated with the commands and scripts for performing the associated customized actions.

In 410, the process can end, but the process can return to any point and repeat.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of performing software provisioning in a software provisioning environment, comprising:
determining at least one action to be performed in association with a software provisioning process, wherein the at least one action is to be performed upon an occurrence of an event;
determining commands to cause the at least one action to be performed; and
associating the commands with the software provisioning process and the event.

2. The method of claim 1, wherein the at least one action is to be performed by at least one of a provisioning server, a provisioning client, a target system, or software of the software provisioning process.

3. The method of claim 1, wherein determining the at least one action, comprises:
receiving a request comprising the at least one action to be performed and the event.

4. The method of claim 1, wherein determining the commands, comprises:
modifying a configuration file for the software provisioning process to include the commands, wherein the configuration file instructs at least one of a provisioning client, a target system, or software of the software provisioning process to perform the action.

5. The method of claim 1, wherein determining the commands, comprises:
generating the commands to cause a provisioning server to perform the at least one action.

6. The method of claim 6, wherein associating the commands with the software provisioning process, comprises:
storing the commands in a record associated with the software provisioning processes and the event.

7. The method of claim 6, further comprising:
monitoring, by the provisioning server, for the occurrence of the event;
retrieving the commands upon occurrence of the event; and
performing the at least one action by executing the commands.

8. A system for registering new systems in a software provisioning environment, comprising:
a network interface to a network comprises at least one target system; and
a provisioning server, communicating with the network interface, the provisioning server being configured to—
determine at least one action to be performed in association with a software provisioning process, wherein the at least one action is to be performed upon an occurrence of an event;
determine commands to cause the at least one action to be performed; and
associate the commands with the software provisioning process and the event.

9. The system of claim 8, wherein the at least one action is to be performed by at least one of a provisioning server, a provisioning client, the at least one target system, or software of the software provisioning process.

10. The system of claim 8, wherein determining the at least one action, comprises:
receiving a request comprising the at least one action to be performed and the event.

11. The system of claim 8, wherein determining the commands, comprises:
modifying a configuration file for the software provisioning process to include the commands, wherein the configuration file instructs at least one of a provisioning client, the at least one target system, or software of the software provisioning process to perform the action.

12. The system of claim 8, wherein determining the commands, comprises:
generating the commands to cause a provisioning server to perform the at least one action.

13. The system of claim 12, wherein associating the commands with the software provisioning process, comprises:
storing the commands in a record associated with the software provisioning processes and the event.

14. The system of claim 12, wherein the provisioning server is further configured to—
monitor for the occurrence of the event;
retrieve the commands upon occurrence of the event; and
perform the at least one action by executing the commands.

15. A provisioning application, the provisioning application being embodied in a computer readable medium and comprising instructions for causing a computer to perform a method comprising:
determining at least one action to be performed in association with a software provisioning process, wherein the at least one action is to be performed upon an occurrence of an event;
determining commands to cause the at least one action to be performed; and
associating the commands with the software provisioning process and the event.

16. The provisioning application of claim 15, wherein the at least one action is to be performed by at least one of a provisioning server, a provisioning client, a target system, or software of the software provisioning process.

17. The provisioning application of claim 15, wherein determining the at least one action, comprises:
receiving a request comprising the at least one action to be performed and the event.

18. The provisioning application of claim 15, wherein determining the commands, comprises:
modifying a configuration file for the software provisioning process to include the commands, wherein the configuration file instructs at least one of a provisioning client, a target system, or software of the software provisioning process to perform the action.

19. The provisioning application of claim 15, wherein determine the commands, comprises:
generating the commands to cause a provisioning server to perform the at least one action.

20. The provisioning application of claim 19, wherein associating the commands with the software provisioning process, comprises:
storing the commands in a record associated with the software provisioning processes and the event.

21. The provisioning application of claim 19, the method further comprising: monitoring, by the provisioning server, for the occurrence of the event; retrieving the commands upon occurrence of the event; and performing the at least one action by executing the commands.
